(19) United States
(12) Patent Application Publication
(10) Pub. No.: US 2026/0017196 A1
(43) Pub. Date: Jan. 15, 2026

(54) Storage and Device

(71) Applicant: Huawei Technologies Co., Ltd., Shenzhen (CN)

(72) Inventors: Xiaoming Zhu, Shanghai (CN); Yigang Zhou, Shanghai (CN)

(73) Assignee: Huawei Technologies Co., Ltd., Shenzhen (CN)

(21) Appl. No.: 19/334,310

(22) Filed: Sep. 19, 2025

Related U.S. Application Data
(63) Continuation of application No. PCT/CN2024/077833, filed on Feb. 20, 2024.

(30) Foreign Application Priority Data
Mar. 22, 2023 (CN) 202310295199.4
Jun. 13, 2023 (CN) 202310700909.7

(51) Int. Cl. G06F 12/06

(52) U.S. Cl. CPC G06F 12/0646; G06F 2212/251

(57) ABSTRACT

A storage includes a first wafer and a second wafer that are stacked. The first wafer is a storage medium wafer, and a medium controller is disposed on the second wafer. The storage medium wafer includes a plurality of regions, each region includes a plurality of dies, and each die includes a plurality of banks. The medium controller is connected to each bank, and the medium controller can receive a data access instruction and access the bank based on the data access instruction. The medium controller can directly control the bank, and can perform operations concurrently on the plurality of banks, so that an amount of data transmitted between the storage medium wafer and the medium controller in a transmission periodicity can be increased, and a bit width of the storage is increased.

### CROSS-REFERENCE TO RELATED APPLICATIONS

This is a continuation of International Patent Application No. PCT/CN2024/077833 filed on Feb. 20, 2024, which claims priority to Chinese Patent Application No. 202310295199.4 filed on Mar. 22, 2023 and Chinese Patent Application No. 202310700909.7 filed on Jun. 13, 2023. All of the aforementioned patent applications are hereby incorporated by reference in their entireties.

### TECHNICAL FIELD

This disclosure relates to the field of storage technologies, and in particular, to a storage and a device.

### BACKGROUND

Currently, one or more dies on a wafer on which a storage medium is disposed are cut off, and then the one or more dies and an input/output (I/O) circuit are packaged in a complementary metal-oxide-semiconductor (CMOS) under array (CUA) architecture, to form a mainstream memory. In this packaging manner, the die and the I/O circuit may be vertically stacked or disposed side by side. Regardless of whether the die and the I/O circuit are vertically stacked or disposed side by side, a quantity of banks in the die is proportional to a size of the I/O circuit. This limits the quantity of banks in the memory. As a result, a capacity of the memory cannot be greatly improved. In addition, the I/O circuit can be connected to an external memory controller through a bus. Consequently, a bit width of the memory (where the bit width of the memory refers to an amount of data transmitted in the memory in a transmission periodicity) is limited by the bus, and the bit width of the memory cannot be expanded.

### SUMMARY

This disclosure provides a storage and a device, to expand a bit width and a capacity of the storage.

According to a first aspect, an embodiment of this disclosure provides a storage, where the storage includes a first wafer and a second wafer that are stacked. The first wafer is a storage medium wafer, in other words, a storage medium is disposed on the first wafer, and a medium controller is disposed on the second wafer. The storage medium wafer is connected to the medium controller. The storage medium wafer may store data. The medium controller can receive a data access instruction, and access the storage medium based on the data access instruction.

The storage medium wafer includes a plurality of regions, each region includes a plurality of dies, each die includes a plurality of banks, and each bank is connected to the medium controller. The bank herein refers to a smaller storage unit included in the die. In different scenarios, the bank may be replaced with different names. In this embodiment of this disclosure, the bank is used as an example. The medium controller may access the bank on the storage medium wafer based on the data access instruction.

According to the foregoing storage, the storage is a wafer-level storage, and an entire wafer is used as a substrate of the storage medium, to ensure that a capacity of the storage can be greatly increased. The medium controller controls the storage medium wafer at a granularity of a bank, to ensure that the storage has a high bit width.

In a possible implementation, the medium controller includes a plurality of sub-controllers, each sub-controller corresponds to one region, and the sub-controller is connected to each bank in the corresponding region.

The sub-controller receives the data access instruction, and accesses the bank in the corresponding region based on the data access instruction.

Based on the foregoing storage, the medium controller includes the plurality of sub-controllers corresponding to the regions, and each sub-controller may concurrently access the bank in the corresponding region, to ensure that the storage can efficiently process the received data access instruction, thereby effectively improving data access efficiency of the storage.

In a possible implementation, the plurality of sub-controllers may not be connected, or the plurality of sub-controllers may be connected. For example, the plurality of sub-controllers communicates with each other by using a network-on-chip (NoC).

Based on the foregoing storage, the plurality of sub-controllers may be flexibly connected or disconnected, which is applicable to different scenarios. The plurality of sub-controllers is connected to each other, so that efficient information exchange can be performed between the plurality of sub-controllers.

In a possible implementation, the plurality of sub-controllers is connected to each other, in other words, the plurality of sub-controllers is fully connected. Any sub-controller is connected to other sub-controllers. Any sub-controller may transmit the data access instruction that cannot be processed by the sub-controller to a sub-controller connected to the sub-controller.

Based on the foregoing storage, because the sub-controllers are fully connected, it is ensured that the data access instruction that cannot be processed by any sub-controller can always be received by another sub-controller that can process the data access instruction.

In a possible implementation, the sub-controller is connected to an adjacent sub-controller, and the sub-controller may transmit, to the adjacent sub-controller, the data access instruction that cannot be processed by the sub-controller.

Based on the foregoing storage, the sub-controller is connected to the adjacent sub-controller in a simple manner. In addition, the data access instruction is transmitted, so that a data access instruction can be finally received by a sub-controller that can process the data access instruction.

In a possible implementation, the plurality of sub-controllers is connected in series to form a ring line, and the sub-controller may broadcast, by using the ring line, the data access instruction that cannot be processed by the sub-controller.

Based on the foregoing storage, the ring line makes a connection line between the plurality of sub-controllers simpler, and there is no need to add too many lines. The sub-controller transmits the data access instruction in a broadcast manner, to ensure that other sub-controllers can receive the data access instruction.

In a possible implementation, the medium controller further includes an I/O module, the I/O module and the plurality of sub-controllers are connected in series to form a ring line, and the I/O module is connected to an apparatus outside the storage through a system bus.

The I/O module receives the data access instruction, and broadcasts the data access instruction by using the ring line. The sub-controller listens to the ring line to obtain the data access instruction.

Based on the foregoing storage, the I/O module is responsible for receiving and forwarding the data access instruction. The apparatus outside the storage only needs to be connected to the I/O module, so that a line between the storage and the external apparatus is simplified. The I/O module transmits the data access instruction in a broadcast manner, to ensure that the plurality of sub-controllers can receive the data access instruction.

In a possible implementation, the sub-controller stores data address information of the corresponding region, where the data address information is used to record a data address of the corresponding region; and a data address carried in the data access instruction that cannot be processed by the sub-controller is not the data address recorded in the data address information.

Based on the foregoing storage, the sub-controller can accurately find, based on the stored data address information of the corresponding region, the data access instruction that cannot be processed.

In a possible implementation, the storage further includes a test module. The test module is configured to perform a function test on the storage medium wafer, and record a bank that fails the test and a die to which the bank belongs in the storage medium wafer. The function test includes a part or all of the following: a read/write test, a delay test, a life test, and a temperature test.

Based on the foregoing storage, the test module is disposed in the storage, and the function test can be performed on the storage medium wafer, to ensure that the storage can have a normal function and work normally.

In a possible implementation, the medium controller may perform a function test on the storage medium wafer, and record a bank that fails the test and a die to which the bank belongs in the storage medium wafer. The function test includes a part or all of the following: a read/write test, a delay test, a life test, and a temperature test.

Based on the foregoing storage, the medium controller can perform the function test on the storage medium wafer, so that the storage can perform a self-check, to ensure that the storage works normally.

According to a second aspect, a computing device is provided. The computing device includes a processor and the storage according to any one of the first aspect or the possible implementations of the first aspect, and the processor is connected to a medium controller in the storage. There may be one or more processors. The processor may send a data access instruction to the storage.

In a possible implementation, the processor is connected to one or more sub-controllers in the medium controller. For example, there are a plurality of processors, and each processor is connected to a sub-controller.

### BRIEF DESCRIPTION OF DRAWINGS

FIG. 1A is a diagram of a structure of a wafer;

FIG. 1B is a flowchart of preparing a memory;

FIG. 1C is a diagram of a connection between a memory I/O circuit and each of a memory controller and each bank;

FIG. 2 is a diagram of a structure of a storage according to an embodiment of this disclosure;

FIG. 3 is a diagram of a connection between a medium controller and a storage medium in a storage according to an embodiment of this disclosure;

FIG. 4A is a diagram of division of regions in a storage medium according to an embodiment of this disclosure;

FIG. 4B is a diagram of a connection between a sub-controller and a storage medium in a storage according to an embodiment of this disclosure;

FIG. 5A and FIG. 5B each are a diagram of a connection between sub-controllers according to an embodiment of this disclosure;

FIG. 6A and FIG. 6B each are a diagram of a connection between sub-controllers according to an embodiment of this disclosure;

FIG. 7A and FIG. 7B each are a diagram of a connection between sub-controllers according to an embodiment of this disclosure;

FIG. 8A and FIG. 8B each are a diagram of a connection between sub-controllers according to an embodiment of this disclosure;

FIG. 9A and FIG. 9B each are a diagram of a connection between sub-controllers according to an embodiment of this disclosure;

FIG. 10 is a diagram of a structure of a storage according to an embodiment of this disclosure; and

FIG. 11 is a diagram of a computing device according to an embodiment of this disclosure.

### DESCRIPTION OF EMBODIMENTS

Before a storage and a system provided in embodiments of this disclosure are described, some concepts in this disclosure are described.

### (1) Wafer

The wafer is short for a semiconductor crystal slice, and a shape of the wafer is usually a cylindrical thin slice. The wafer is usually used to prepare components such as a computer chip, a storage, and a solar cell. For example, a computer chip with a computing function can be formed by integrating circuit logic on the wafer. For another example, a storage can be formed by packaging a storage medium and an I/O circuit which are disposed on the wafer. For another example, a solar cell can be formed by depositing a P-type thin film and an N-type thin film on the wafer. The most common wafers are silicon wafers, gallium nitride wafers, silicon carbide wafers, and the like.

In embodiments of this disclosure, the storage includes a first wafer and a second wafer. The first wafer is a storage medium wafer, and a medium controller is disposed on the second wafer. The storage medium wafer and the wafer provided with the medium controller are stacked, to form a stacking structure.

### (2) Storage Medium and Storage

The storage medium is a substance or a component that can be used to store binary codes “0” and “1”. The storage medium has two stable physical states. A specific physical state of the storage medium can be determined in some manners (for example, a manner of detecting a voltage or a resistance value), to determine whether “0” or “1” is stored in the storage medium. For the storage medium, the two physical states can be converted, to implement a conversion from “0” to “1” or from “1” to “0”.

In embodiments of this disclosure, the storage is an apparatus that can process a data access instruction and perform data access on data stored in the storage. In other words, the storage has a data processing function and a data access instruction processing function.

The following describes a common process of preparing a memory by using a wafer.

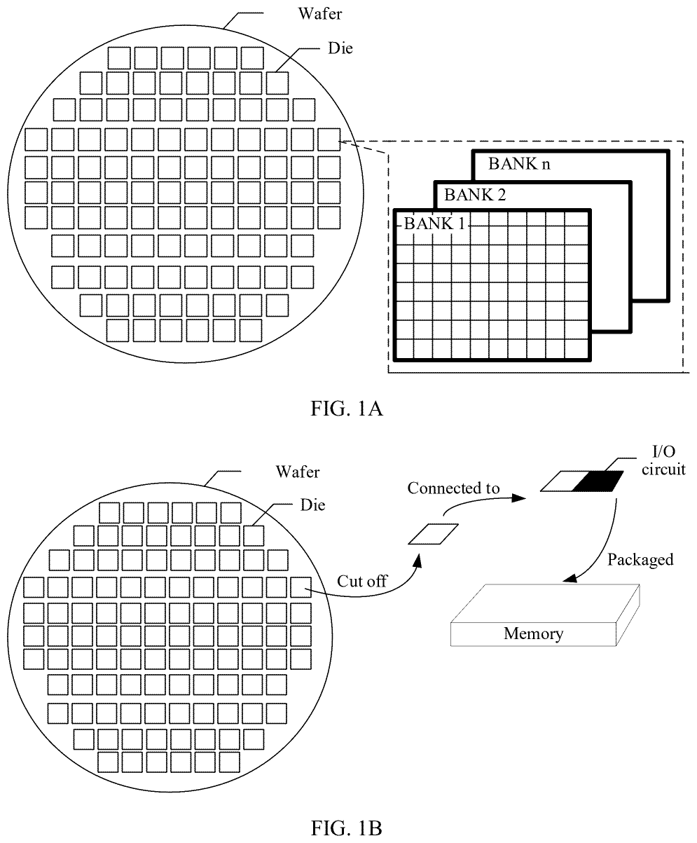

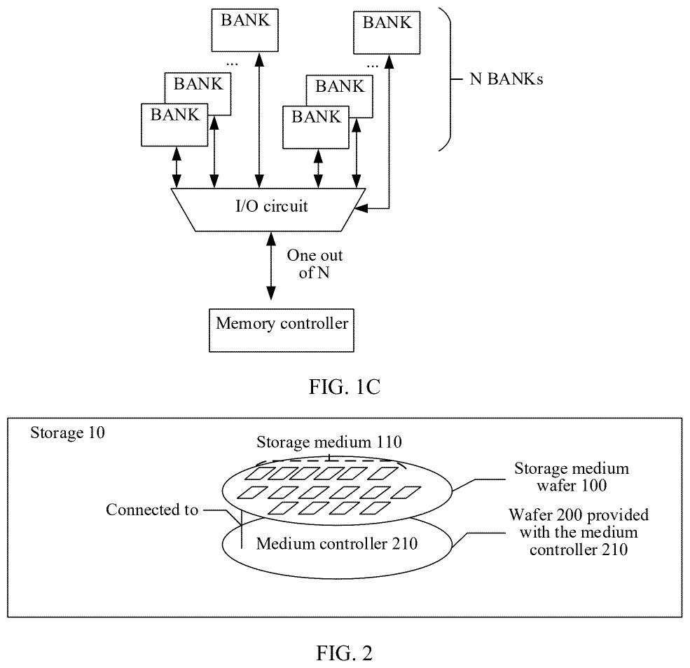

Generally, lattice-shaped dies are formed on the wafer by means such as lithography, doping, and the like. FIG. 1A shows a wafer on which lattice-shaped dies are formed, where each small square represents a die. For the memory, each die includes a plurality of banks. Each bank may be considered as a rectangular grid array including a plurality of grids. The rectangular grid array includes the grids of a plurality of columns and a plurality of rows, and these grids are used to store data.

As shown in FIG. 1B, a final test (FT) function is performed on dies cut off from the wafer. A die that is synthesized after the test may be used to prepare the memory. The cut die only has a basic data storage function, and cannot directly process an instruction initiated by a memory controller to read and write data. Therefore, an I/O circuit needs to be configured for each die. After the die is connected to the I/O circuit, the die and the I/O circuit are packaged together to form the memory.

As shown in FIG. 1C, the I/O circuit is connected to each bank on the die, and the I/O circuit can read data from each bank or write data into each bank. The I/O circuit can be connected to an external memory controller through a bus, and can read or write data in each connected bank by using the memory controller. Due to a limitation of a bus bandwidth, an amount of data transmitted between the I/O circuit and the memory controller at a time is fixed. A process of outputting data in the die to the memory controller is used as an example. It is assumed that each die includes N banks. Due to the limitation of the bus bandwidth, the amount of data transmitted between the I/O circuit and the memory controller at a time is eight bits (where transmitted at a time herein refers to data transmission completed in a transmission periodicity). If each bank can output eight-bit data at a time, the I/O circuit cannot transmit data output by each bank to the memory controller during one transmission, but needs to perform a one out of N selection operation, in other words, only data output by one bank can be transmitted at a time. One memory may include one or more dies. An amount of data transmitted between the memory and the memory controller at a time is referred to as a bit width of the memory. It can be seen that the bit width of the memory is fixed.

In addition, when the die and the I/O circuit are packaged, a CUA architecture may be used. The architecture requires a size of the die to be consistent with a size of the I/O circuit. Due to this limitation, there is a relationship between a quantity of banks in the die and the size of the I/O circuit, and a size of the bank in the die cannot be greatly increased. As a result, a capacity of the memory cannot be effectively increased.

In this embodiment of this disclosure, the storage includes stacked wafers. The storage medium is disposed on one wafer, and the medium controller is disposed on another wafer. The storage medium is connected to the medium controller. The storage medium includes a plurality of banks, and each bank in the storage medium is connected to the medium controller. The medium controller can directly control each bank in the storage medium. In the storage, the storage medium is disposed on the wafer, which effectively expands a capacity of the storage. An amount of data transmitted between the medium controller and the storage medium at a time is related to a quantity of banks connected to the medium controller. A larger quantity of banks connected to the medium controller indicates a larger amount of data transmitted between the medium controller and the storage medium at a time, that is, a larger bit width of the storage.

The following describes a structure of a storage according to an embodiment of this disclosure with reference to the accompanying drawings. FIG. 2 shows a storage according to an embodiment of this disclosure. The storage 10 is a wafer-level storage. In other words, the storage 10 is a storage formed by using an entire wafer. In terms of a size of the storage 10, an area of the storage 10 is greater than or equal to an area of the wafer.

In terms of a structure, the storage 10 includes stacked wafers. A wafer 100 is used as a substrate of a storage medium 110, and the storage medium 110 is disposed on the wafer 100. In other words, a substance or a component used to implement a storage function is prepared on the wafer 100. The wafer 100 may also be referred to as a storage medium wafer 100. A type of the storage medium 110 is not limited in this embodiment of this disclosure. For example, the storage medium 110 may be a read-only memory (ROM), a dynamic random-access memory (DRAM), a storage class memory (SCM), a static random-access memory (SRAM), a dual in-line memory module or a double in-line memory module (DIMM), a flash memory, or a NAND flash memory. Any storage medium 110 that can be prepared by using the wafer as a substrate is applicable to this embodiment of this disclosure.

Another wafer 200 is used as a substrate of a medium controller 210 in the storage 10, and the medium controller 210 is disposed on the wafer 200. In other words, circuit logic related to the medium controller 210 is prepared on the wafer 200. When the storage 10 is used as a memory in a computing device, the medium controller 210 may be understood as a memory controller. When the storage 10 is a non-memory storage 10, the medium controller 210 is a controller that is disposed in the storage 10 and has a control function.

The medium controller 210 is a control core in the storage 10. The medium controller 210 receives a data access instruction sent by an apparatus (for example, a processor) outside the storage 10, and parses and processes the data access instruction. The medium controller 210 can further control the storage medium 110, to access data stored in the storage medium 110, that is, to complete reading and writing of the data (the data is understood as “0” and “1” mentioned in the foregoing content).

For example, in a process of processing the data access instruction, when the medium controller 210 determines that the data access instruction requests to read the data, the medium controller 210 may read the data from the storage medium 110. For another example, in a process of processing the data access instruction, when the medium controller 210 determines that the data access instruction requests to write the data, the medium controller 210 may write, to the storage medium 110, the data that is requested to be written by the data access instruction.

The storage medium wafer 100 is connected to the medium controller 210. For example, the storage medium wafer 100 may be connected to the medium controller 210 by using a non-bus line. The non-bus line is a line that is not constrained by a related protocol standard. For ease of distinguishing, a line between the storage medium 110 and the medium controller 210 in the storage 10 is referred to as an internal line, and the internal line may be a non-bus line. In other words, the internal line is not a line in a standard such as a double-data-rate (DDR) bus, an Open NAND Flash Interface (ONFI), or a Toggle. In this way, data transmission between the medium controller 210 and the storage medium 110 is no longer limited by a bus, a bandwidth and a quantity of internal lines may be designed based on an actual requirement, and the medium controller 210 can efficiently access the storage medium 110.

It should be noted that there are some buses with high bandwidths in buses in the existing storage 10, for example, a high bandwidth memory (HBM) 10. In this embodiment of this disclosure, the bus with the high bandwidth may also be used between the storage medium wafer 100 and the medium controller 210.

The following describes structures of the storage medium 110 and the medium controller 210.

### (1) Storage Medium 110

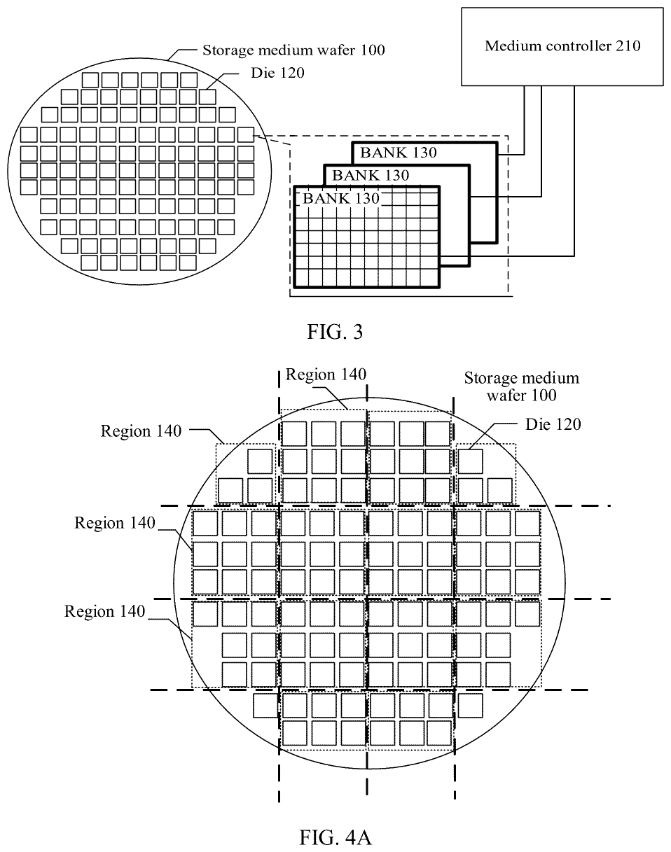

As shown in FIG. 3, the storage medium wafer 100 includes lattice-shaped dies 120, and each die 120 includes a plurality of banks 130. Each bank 130 is connected to the medium controller 210 (for example, connected by using an internal line). In other words, the medium controller 210 can directly control each bank 130 to perform data access on each bank 130.

In this embodiment of this disclosure, on the storage medium wafer 100, no separate I/O circuit is disposed on the die 120, and the medium controller 210 controls the storage medium 110 at a granularity of the bank 130 instead of a granularity of the die 120.

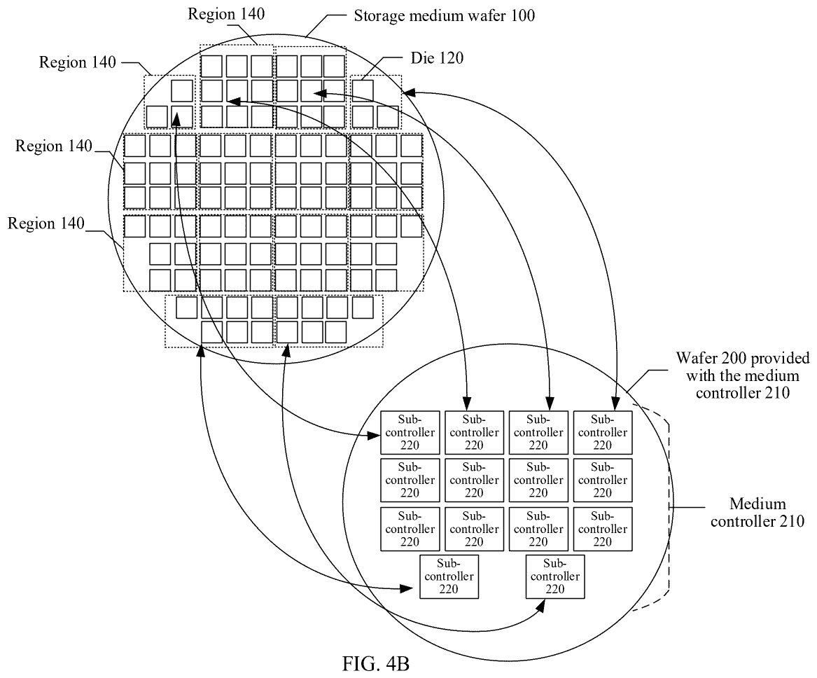

As shown in FIG. 4A, to facilitate the medium controller 210 to control the storage medium 110, the lattice-shaped dies 120 on the storage medium wafer 100 may be divided into a plurality of regions 140. Each region 140 includes a plurality of dies 120, and each region 140 corresponds to one sub-controller 220 in the medium controller 210. The following describes the structure of the medium controller 210.

### (2) Medium Controller 210

As shown in FIG. 4B, the medium controller 210 includes a plurality of sub-controllers 220. Each sub-controller 220 corresponds to one region 140 in the storage medium 110, and is configured to control the bank 130 in the corresponding region 140, to access data in the region 140.

For any sub-controller 220, a bank 130 of each die 120 in a region 140 corresponding to the sub-controller 220 is connected to the sub-controller 220; or a read/write circuit of each bank 130 in the region 140 corresponding to each sub-controller 220 is connected to the sub-controller 220. In this case, the sub-controller 220 can synchronously access each bank 130 in each die 120 in the corresponding region 140.

In this embodiment of this disclosure, the medium controller 210 (for example, each sub-controller 220) may be directly connected to the bank 130. The medium controller 210 can directly change a physical state of the bank 130 (that is, a physical state of a part of the storage medium 110 corresponding to the bank 130), to implement writing or reading of “0” or “1”.

Optionally, a corresponding read/write circuit is disposed for each bank 130, and the read/write circuit can read data from or write data into grids in the bank 130 under control of the medium controller 210. The read/write circuit is connected to the bank 130 and the medium controller 210. The read/write circuit can change the physical state of the bank 130 (that is, the physical state of a part of the storage medium 110 corresponding to the bank 130) under an indication of the medium controller 210, to implement writing of “0” or “1”. The read/write circuit can further detect the physical state of the bank 130 under an indication of the medium controller 210, to implement reading of “0” or “1”. In a scenario in which the read/write circuit is disposed, the read/write circuit of each bank 130 is connected to the medium controller 210, to ensure that the medium controller 210 can control each bank 130 by using the read/write circuit.

The read/write circuit is used as a part of the storage 10. A location of the read/write circuit in the storage 10 is not limited in this embodiment of this disclosure. The read/write circuit may be located on the storage medium wafer 100, or may be located on the wafer 200 on which the medium controller 210 is located. In some scenarios, a part of the read/write circuit may be located on the storage medium wafer 100, and another part of the read/write circuit may be located on the wafer 200 on which the medium controller 210 is located.

Control of the sub-controller 220 or the medium controller 210 on the connected banks 130 may be associated, or may be independent. The sub-controller 220 is used as an example. When the sub-controller 220 controls the banks 130 in the corresponding region 140, the sub-controller 220 may synchronously write data into the banks 130 in the corresponding region 140, or synchronously read data from the banks 130 in the corresponding region 140. In other words, in a period of time, the sub-controller 220 performs a same operation on the banks 130 in the corresponding region 140. In this control manner, control of the sub-controller 220 on the connected banks 130 is associated. When the sub-controller 220 controls the banks 130 in the corresponding region 140, the sub-controller 220 may perform different operations on different banks 130 in the corresponding region 140. The sub-controller 220 may read data from one bank 130 in the corresponding region 140 and write data into another bank 130 in the corresponding region 140 at a same time. In other words, in a period of time, the sub-controller 220 may perform different operations on the banks 130 in the corresponding region 140. In this control manner, control of the sub-controller 220 on the connected banks 130 is independent.

Types of the sub-controller 220 and the medium controller 210 are not limited in this embodiment of this disclosure. The sub-controller 220 and the medium controller 210 each may be an application-specific integrated circuit (ASIC), a field-programmable gate array (FPGA) or another programmable logic device, a discrete gate or transistor logic device, a discrete hardware component, or the like.

Externally, the sub-controller 220 may be connected to an external apparatus (for example, an external processor) through a system bus, and receives an external data access instruction. The sub-controller 220 receives the data access instruction, and processes the data access instruction. In a process of processing the data access instruction, the sub-controller 220 can access the bank 130 in the corresponding region 140 based on the data access instruction.

In this embodiment of this disclosure, there may be no connection between the plurality of sub-controllers 220, in other words, the sub-controllers 220 do not communicate with each other. Each sub-controller 220 can access each bank 130 in the corresponding region 140, and cannot access a bank 130 in another region 140.

A connection may alternatively be established between the plurality of sub-controllers 220, in other words, the sub-controllers 220 may communicate with each other. When the plurality of sub-controllers 220 are connected, the sub-controllers 220 may exchange information with each other. For example, a sub-controller 220 can transmit the data access instruction that cannot be processed by the sub-controller 220 to a sub-controller 220 connected to the sub-controller 220. For another example, a sub-controller 220 may obtain, from a connected sub-controller 220, an access response of the connected sub-controller 220 to the data access instruction. In this embodiment of this disclosure, the plurality of sub-controllers 220 may be connected by using an NoC, or may be connected by using another line. All lines that can be connected to the plurality of sub-controllers 220 are applicable to this embodiment of this disclosure.

Optionally, for any sub-controller 220, the sub-controller 220 may be connected to a bank 130 in an adjacent region 140 of the bank 130 in the corresponding region 140, that is, may access the bank 130 in the adjacent region 140 of the bank 130 in the corresponding region 140. The sub-controller 220 may be connected to the bank 130 in the adjacent region 140 of the bank 130 in the corresponding region 140 by using the NoC.

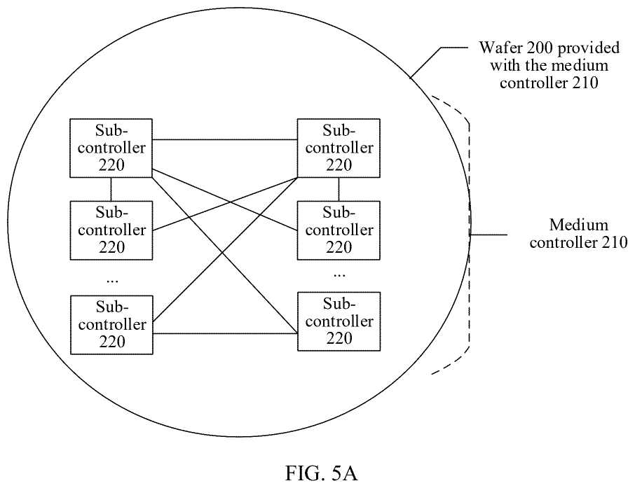

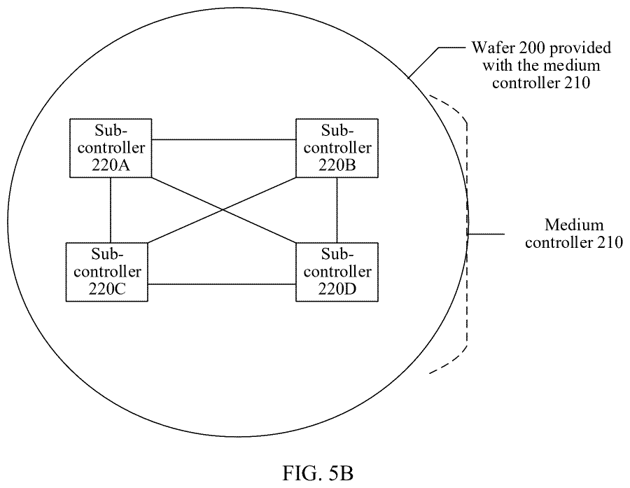

The following lists several connection manners between the plurality of sub-controllers 220 on the wafer 200 on which the medium controller 210 is disposed.
Manner 1: As shown in FIG. 5A, the medium controller 210 includes the plurality of sub-controllers 220, and any two sub-controllers 220 are connected. Any sub-controller 220 can transfer a data access instruction that cannot be processed by the sub-controller 220 to each connected sub-controller 220.

Each controller stores data address information of a corresponding region 140. The data address information records a data address of the region 140. For any sub-controller 220, after receiving a data access instruction sent by an external apparatus, the sub-controller 220 may first detect data address information of a corresponding region 140 based on a data address carried in the data access instruction, and determine whether the data address carried in the data access instruction is a data address of the region 140. If the data address carried in the data access instruction is the data address of the region 140, the sub-controller 220 continues to process the data access instruction. After processing the data access instruction, the sub-controller 220 may further feed back an access response to the external apparatus. For a data access instruction that requests to read data, the access response carries data read from the corresponding region 140 by the sub-controller 220. For a data access instruction that requests to write data, the access response indicates that data writing succeeds or fails. If the data address carried in the data access instruction is not the data address of the region 140, the data access instruction is the data access instruction that cannot be processed by the sub-controller 220, and the sub-controller 220 may transfer the data access instruction to the connected sub-controller 220.

In this connection manner, the sub-controller 220 is connected to all sub-controllers 220 in the medium controller 210 except the sub-controller 220, in other words, there is always a sub-controller 220 that can process the data access instruction and that is in the sub-controllers 220 connected to the sub-controller 220.

After receiving the data access instruction transmitted by the sub-controller 220, any sub-controller 220 connected to the sub-controller 220 first detects data address information of a corresponding region 140 based on the data address carried in the data access instruction, and determines whether the data address carried in the data access instruction is a data address of the region 140. If the data address carried in the data access instruction is the data address of the region 140, the data access instruction is processed. The sub-controller 220 connected to the sub-controller 220 may further feed back an access response to the sub-controller 220. For description of the access response, refer to the foregoing content. Details are not described herein again. If the data address carried in the data access instruction is not the data address of the region 140, the sub-controller 220 connected to the sub-controller 220 may discard the data access instruction.

FIG. 5B is a topology diagram of a connection between a plurality of sub-controllers 220 according to an embodiment of this disclosure. In FIG. 5B, the medium controller 210 includes four sub-controllers 220, which are respectively referred to as a sub-controller 220A, a sub-controller 220B, a sub-controller 220C, and a sub-controller 220D for ease of description. Regions 140 corresponding to the sub-controller 220A, the sub-controller 220B, the sub-controller 220C, and the sub-controller 220D are respectively referred to as a region 140A, a region 140B, a region 140C, and a region 140D. The sub-controller 220A, the sub-controller 220B, the sub-controller 220C, and the sub-controller 220D are connected to different processors.

Any two sub-controllers 220 are connected. For example, the sub-controller 220A is separately connected to the sub-controller 220B, the sub-controller 220C, and the sub-controller 220D.

When the sub-controller 220A receives a data access instruction sent by an external processor, the sub-controller 220A first detects data address information of the region 140A based on a data address carried in the data access instruction, and determines whether the data address carried in the data access instruction is a data address of the region 140A. If the data address carried in the data access instruction is the data address of the region 140A, the sub-controller 220A continues to process the data access instruction. After processing the data access instruction, the sub-controller 220A may feed back an access response to the external processor. For description of the access response, refer to the foregoing content. Details are not described herein again. If the data address carried in the data access instruction is not the data address of the region 140A, the sub-controller 220A transfers the data access instruction to the sub-controller 220B, the sub-controller 220C, and the sub-controller 220D.

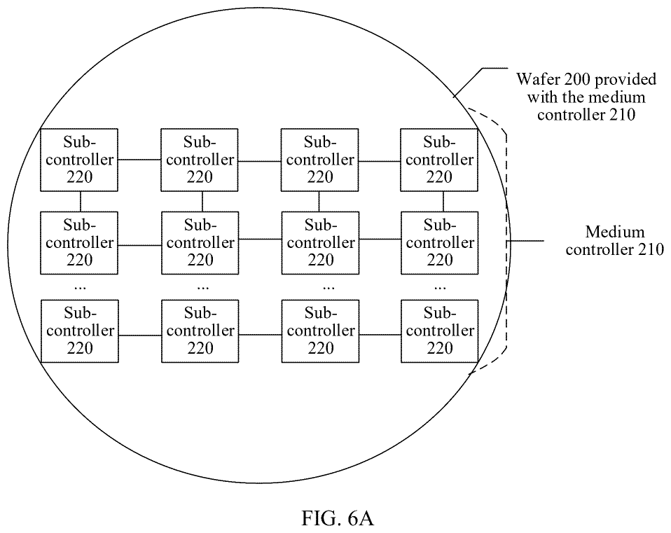

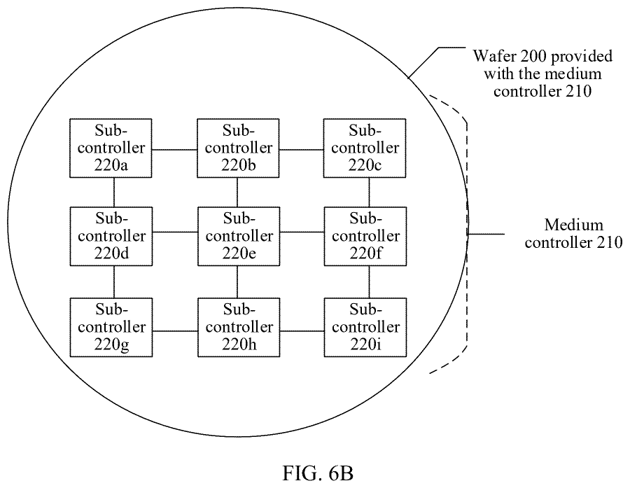

The sub-controller 220B is used as an example. After receiving the data access instruction transmitted by the sub-controller 220A, the sub-controller 220B first detects data address information of the region 140B based on the data address carried in the data access instruction, and determines whether the data address carried in the data access instruction is a data address of the region 140B. If the data address carried in the data access instruction is the data address of the region 140B, the data access instruction is processed. The sub-controller 220B may further feed back an access response to the sub-controller 220A. For description of the access response, refer to the foregoing content. Details are not described herein again. If the data address carried in the data access instruction is not the data address of the region 140B, the sub-controller 220B may discard the data access instruction.
Manner 2: As shown in FIG. 6A, the medium controller 210 includes the plurality of sub-controllers 220, and any sub-controller 220 is connected only to an adjacent sub-controller 220. Any sub-controller 220 can transfer a data access instruction that cannot be processed by the sub-controller 220 to an adjacent sub-controller 220.

Each controller stores data address information of a corresponding region 140. The data address information records a data address of the region 140. For any sub-controller 220, after receiving a data access instruction initiated by an external apparatus, the sub-controller 220 may first detect data address information of a corresponding region 140 based on a data address carried in the data access instruction, and determine whether the data address carried in the data access instruction is a data address of the region 140. If the data address carried in the data access instruction is the data address of the region 140, the sub-controller 220 continues to process the data access instruction. After processing the data access instruction, the sub-controller 220 may further feed back an access response to the external apparatus. For description of the access response, refer to the foregoing content. Details are not described herein again. If the data address carried in the data access instruction is not the data address of the region 140, the sub-controller 220 may transfer the data access instruction to an adjacent sub-controller 220.

In this connection manner, the sub-controller 220 is connected only to an adjacent sub-controller 220. When there is a large quantity of sub-controllers 220, the sub-controller 220 cannot transfer the data access instruction to all sub-controllers 220 except the sub-controller 220. After receiving the data access instruction transmitted by the sub-controller 220, any sub-controller 220 adjacent to the sub-controller 220 may also transmit the data access instruction to an adjacent sub-controller 220 of the any sub-controller 220 if the data access instruction cannot be processed.

After receiving the data access instruction transmitted by the sub-controller 220, any sub-controller 220 adjacent to the sub-controller 220 first detects data address information of a corresponding region 140 based on the data address carried in the data access instruction, and determines whether the data address carried in the data access instruction is a data address of the region 140. If the data address carried in the data access instruction is the data address of the region 140, the data access instruction is processed. The sub-controller 220 adjacent to the sub-controller 220 may further feed back an access response to the sub-controller 220. For a data access instruction that requests to read data, the access response carries data read from the corresponding region 140 by the sub-controller 220 adjacent to the sub-controller 220. For a data access instruction that requests to write data, the access response indicates that data writing succeeds or fails. If the data address carried in the data access instruction is not the data address of the region 140, the sub-controller 220 adjacent to the sub-controller 220 continues to transfer the data access instruction to an adjacent sub-controller 220.

In this manner, the data access instruction that cannot be processed by the sub-controller 220 can always be transferred to a sub-controller 220 that can process the data access instruction. After the sub-controller 220 that can process the data access instruction completes processing the data access instruction, the sub-controller 220 may transfer, based on a path for transferring the data access instruction to the sub-controller 220, the access response to the sub-controller 220 that initially receives the data access instruction, and the sub-controller 220 that initially receives the data access instruction feeds back the access response to the external apparatus.

FIG. 6B is a topology diagram of a connection between a plurality of sub-controllers 220 according to an embodiment of this disclosure. In FIG. 6B, the medium controller 210 includes nine sub-controllers 220, which are respectively referred to as a sub-controller 220a, a sub-controller 220b, a sub-controller 220c, a sub-controller 220d, a sub-controller 220e, a sub-controller 220f, a sub-controller 220g, a sub-controller 220h, and a sub-controller 220i for ease of description. Regions 140 corresponding to the sub-controller 220a, the sub-controller 220b, the sub-controller 220c, the sub-controller 220d, the sub-controller 220e, the sub-controller 220f, the sub-controller 220g, the sub-controller 220h, and the sub-controller 220i are respectively referred to as a region 140a, a region 140b, a region 140c, a region 140d, a region 140e, a region 140f, a region 140g, a region 140h, and a region 140i. The sub-controller 220a, the sub-controller 220b, the sub-controller 220c, the sub-controller 220d, the sub-controller 220e, the sub-controller 220f, the sub-controller 220g, the sub-controller 220h, and the sub-controller 220i are respectively connected to different processors outside the storage 10.

There is a connection line between any sub-controller 220 and an adjacent sub-controller 220. For example, there is a connection line between the sub-controller 220a and each of the adjacent sub-controller 220b and sub-controller 220d. There is a connection line between the sub-controller 220e and each of the adjacent sub-controller 220b, sub-controller 220d, sub-controller 220f, and sub-controller 220h.

When the sub-controller 220a receives a data access instruction sent by an external processor, the sub-controller 220a first detects data address information of the region 140a based on a data address carried in the data access instruction, and determines whether the data address carried in the data access instruction is a data address of the region 140a. If the data address carried in the data access instruction is the data address of the region 140a, the sub-controller 220a continues to process the data access instruction. After processing the data access instruction, the sub-controller 220a may feed back an access response to the external processor. For description of the access response, refer to the foregoing content. Details are not described herein again. If the data address carried in the data access instruction is not the data address of the region 140a, the sub-controller 220a transfers the data access instruction to the adjacent sub-controller 220b and sub-controller 220d.

The sub-controller 220d is used as an example. After receiving the data access instruction transmitted by the sub-controller 220a, the sub-controller 220d first detects data address information of the region 140d based on the data address carried in the data access instruction, and determines whether the data address carried in the data access instruction is a data address of the region 140d. If the data address carried in the data access instruction is the data address of the region 140d, the data access instruction is processed. The sub-controller 220d may further feed back an access response to the sub-controller 220a, and the sub-controller 220a feeds back the feedback response to the external processor. If the data address carried in the data access instruction is not the data address of the region 140d, the sub-controller 220d may transfer the data access instruction to the adjacent sub-controller 220e and sub-controller 220g. Although the sub-controller 220a is also adjacent to the sub-controller 220d, because the data access instruction is received from the sub-controller 220a, the sub-controller 220d may no longer transmit the data access instruction to the sub-controller 220a.

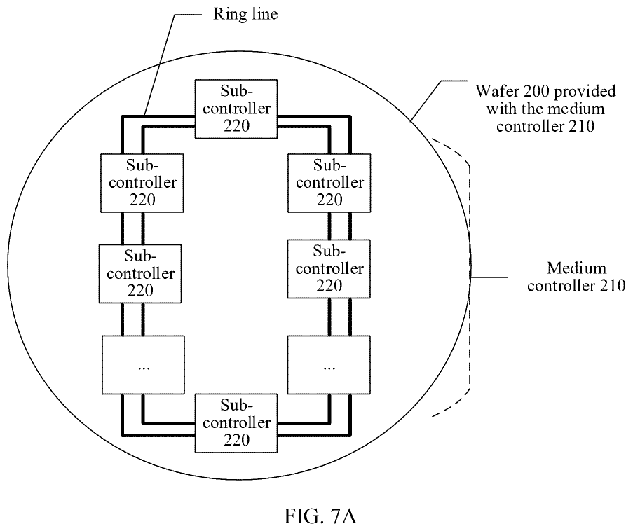

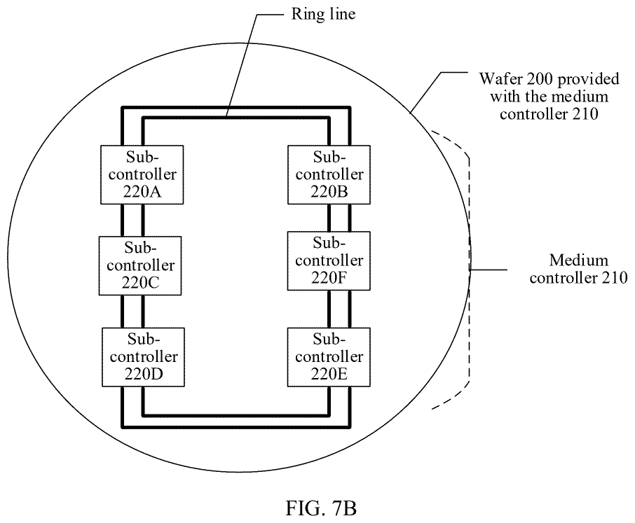

The sub-controller 220g is used as an example. After receiving the data access instruction transmitted by the sub-controller 220d, the sub-controller 220g first detects data address information of the region 140g based on the data address carried in the data access instruction, and determines whether the data address carried in the data access instruction is a data address of the region 140g. If the data address carried in the data access instruction is the data address of the region 140g, the data access instruction is processed. The sub-controller 220g may further feed back an access response to the sub-controller 220d, the sub-controller 220d feeds back the access response to the sub-controller 220a, and the sub-controller 220a feeds back the feedback response to the external processor. If the data address carried in the data access instruction is not the data address of the region 140g, the sub-controller 220g may transfer the data access instruction to the adjacent sub-controller 220b, sub-controller 220f, and sub-controller 220h.
Manner 3: As shown in FIG. 7A, the medium controller 210 includes the plurality of sub-controllers 220, and the plurality of sub-controllers 220 is connected in series by using a ring line, in other words, a connection line between the plurality of sub-controllers 220 forms a ring line. Any sub-controller 220 may broadcast, by using the ring line, a data access instruction that cannot be processed to other sub-controllers 220 on the ring line. Any sub-controller 220 on the ring line monitors the data access instruction broadcast on the ring line, and if a data address carried in the data access instruction is a data address of a corresponding region 140, the sub-controller 220 processes the data access instruction. After processing the data access instruction, the sub-controller 220 can further broadcast, by using the ring line, an access response to other sub-controllers 220 on the ring line, and a sub-controller 220 that initially receives the data access instruction can obtain the access response.

Each controller stores data address information of a corresponding region 140. The data address information records a data address of the region 140. For any sub-controller 220, after receiving a data access instruction initiated by an external apparatus, the sub-controller 220 may first detect data address information of a corresponding region 140 based on a data address carried in the data access instruction, and determine whether the data address carried in the data access instruction is a data address of the region 140. If the data address carried in the data access instruction is the data address of the region 140, the sub-controller 220 continues to process the data access instruction. After processing the data access instruction, the sub-controller 220 may feed back an access response to an external processor. For description of the access response, refer to the foregoing content. Details are not described herein again. If the data address carried in the data access instruction is not the data address of the region 140, the sub-controller 220 may discard the data access instruction.

In this connection manner, because the ring line is connected to all sub-controllers 220, a manner of broadcasting the data access instruction can ensure that all the sub-controllers 220 on the ring line can receive the data access instruction. In other words, the data access instruction can always be detected by a sub-controller 220 that can process the data access instruction.

FIG. 7B is a topology diagram of a connection between a plurality of sub-controllers 220 according to an embodiment of this disclosure. In FIG. 7B, the medium controller 210 includes six sub-controllers 220, which are respectively referred to as a sub-controller 220A, a sub-controller 220B, a sub-controller 220C, a sub-controller 220D, a sub-controller 220E, and a sub-controller 220F for ease of description. Regions 140 corresponding to the sub-controller 220A, the sub-controller 220B, the sub-controller 220C, the sub-controller 220D, the sub-controller 220E, and the sub-controller 220F are respectively referred to as a region 140A, a region 140B, a region 140C, a region 140D, a region 140E, and a region 140F. The sub-controller 220A, the sub-controller 220B, the sub-controller 220C, the sub-controller 220D, the sub-controller 220E, and the sub-controller 220F are respectively connected to different processors outside the storage 10.

The sub-controller 220A, the sub-controller 220B, the sub-controller 220C, the sub-controller 220D, the sub-controller 220E, and the sub-controller 220F are connected by using a ring line.

When the sub-controller 220A receives a data access instruction sent by an external processor, the sub-controller 220A first detects data address information of the region 140A based on a data address carried in the data access instruction, and determines whether the data address carried in the data access instruction is a data address of the region 140A. If the data address carried in the data access instruction is the data address of the region 140A, the sub-controller 220A continues to process the data access instruction. If the data address carried in the data access instruction is not the data address of the region 140A, the sub-controller 220A broadcasts the data access instruction on the ring line. In this way, the sub-controller 220B, the sub-controller 220C, the sub-controller 220D, the sub-controller 220E, and the sub-controller 220F can listen to the data access instruction by using information transmitted in the ring line.

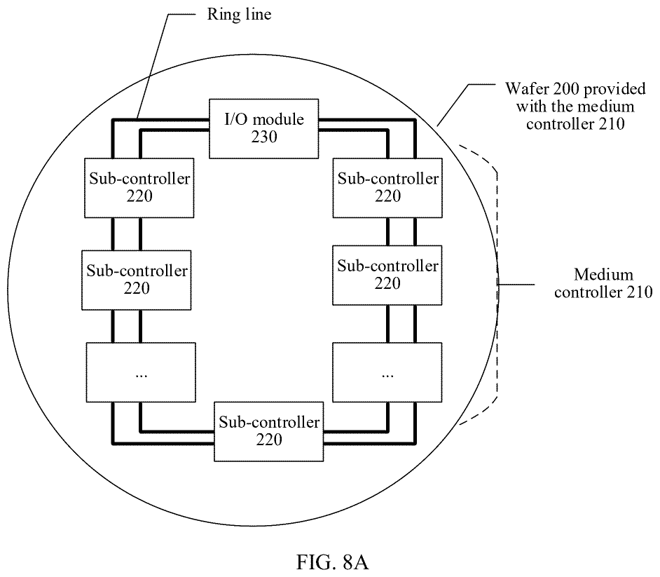

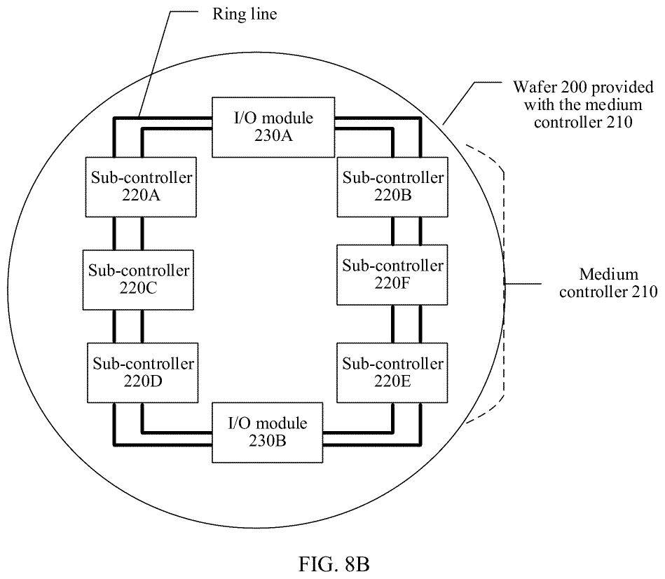

The sub-controller 220B is used as an example. After listening to the data access instruction, the sub-controller 220B first detects data address information of the region 140B based on the data address carried in the data access instruction, and determines whether the data address carried in the data access instruction is a data address of the region 140B. If the data address carried in the data access instruction is the data address of the region 140B, the data access instruction is processed. The sub-controller 220B broadcasts an access response of the data access instruction on the ring line. If the data address carried in the data access instruction is not the data address of the region 140B, the sub-controller 220B may discard the data access instruction.
Manner 4: As shown in FIG. 8A, the medium controller 210 includes an I/O module 230 and the plurality of sub-controllers 220. The I/O module 230 is configured to communicate with an external apparatus, receive a data access response initiated by an external apparatus, or feed back an access response to an external apparatus. A quantity of I/O modules 230 is not limited in this embodiment of this disclosure.

The I/O module 230 and the plurality of sub-controllers 220 are connected in series to form a ring, and a connection line between the I/O module 230 and the plurality of sub-controllers 220 forms a ring line. The I/O module 230 may broadcast, by using the ring line, a data access instruction sent from the external apparatus to the sub-controller 220 on the ring line. Any sub-controller 220 on the ring line monitors the data access instruction broadcast on the ring line, and if a data address carried in the data access instruction is a data address of a corresponding region 140, the sub-controller 220 processes the data access instruction. After processing the data access instruction, the sub-controller 220 can further broadcast an access response by using the ring line, and the I/O module 230 obtains the access response by listening to information transmitted on the ring line.

Each controller stores data address information of a corresponding region 140. The data address information records a data address of the region 140. For any sub-controller 220, the sub-controller 220 listens to information transmitted in the ring line. After detecting the data access instruction, the sub-controller 220 may first detect data address information of a corresponding region 140 based on a data address carried in the data access instruction, and determine whether the data address carried in the data access instruction is a data address of the region 140. If the data address carried in the data access instruction is the data address of the region 140, the sub-controller 220 continues to process the data access instruction. If the data address carried in the data access instruction is not the data address of the region 140, the sub-controller 220 may discard the data access instruction.

In this connection manner, because the ring line is connected to all sub-controllers 220, a manner of broadcasting the data access instruction can ensure that all the sub-controllers 220 on the ring line can receive the data access instruction. In other words, the data access instruction can always be detected by a sub-controller 220 that can process the data access instruction.

FIG. 8B is a topology diagram of a connection between a plurality of sub-controllers 220 according to an embodiment of this disclosure. In FIG. 8B, the medium controller 210 includes two I/O modules 230 and six sub-controllers 220. For ease of description, the I/O modules 230 are respectively an I/O module 230A and an I/O module 230B. The six sub-controllers 220 are respectively referred to as a sub-controller 220A, a sub-controller 220B, a sub-controller 220C, a sub-controller 220D, a sub-controller 220E, and a sub-controller 220F. Regions 140 corresponding to the sub-controller 220A, the sub-controller 220B, the sub-controller 220C, the sub-controller 220D, the sub-controller 220E, and the sub-controller 220F are respectively referred to as a region 140A, a region 140B, a region 140C, a region 140D, a region 140E, and a region 140F.

The I/O module 230A, the I/O module 230B, the sub-controller 220A, the sub-controller 220B, the sub-controller 220C, the sub-controller 220D, the sub-controller 220E, and the sub-controller 220F are connected by using a ring line. The I/O module 230A and the I/O module 230B may be connected to an external device through a system bus.

The I/O module 230A is used as an example. When the I/O module 230A receives a data access instruction sent by an external processor, the I/O module 230A broadcasts the data access instruction by using the ring line.

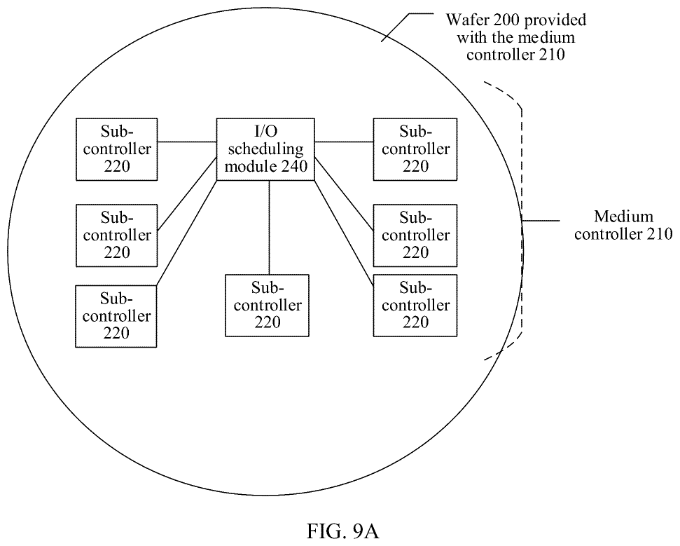

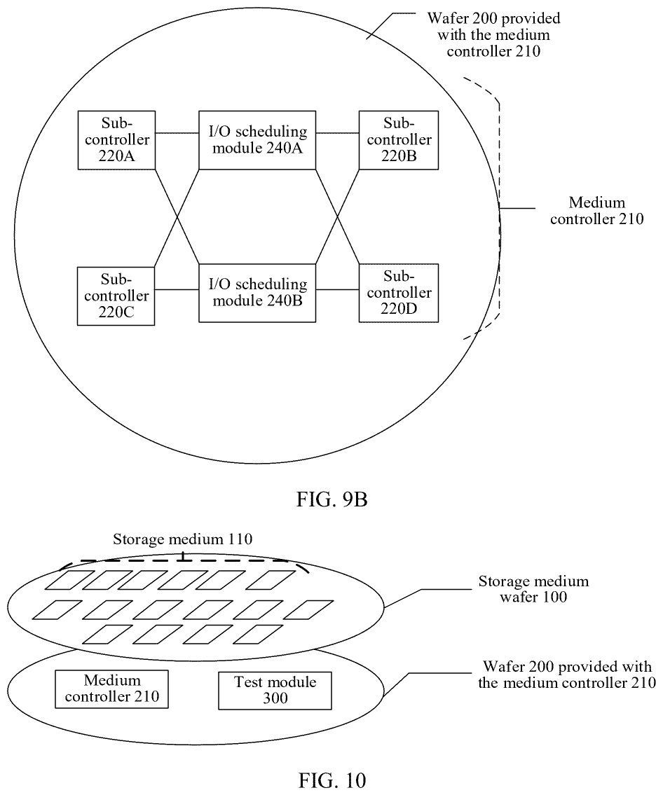

The sub-controller 220A is used as an example. When the sub-controller 220A receives a data access instruction sent by an external processor, the sub-controller 220A first detects data address information of the region 140A based on a data address carried in the data access instruction, and determines whether the data address carried in the data access instruction is a data address of the region 140A. If the data address carried in the data access instruction is the data address of the region 140A, the sub-controller 220A continues to process the data access instruction. After the processing, an access response is broadcast by using the ring line. The I/O module 230A listens to information in the ring line, obtains the access response, and transmits the access response to the external processor. If the data address carried in the data access instruction is not the data address of the region 140A, the sub-controller 220A discards the data access instruction.
Manner 5: As shown in FIG. 9A, the medium controller 210 includes an I/O scheduling module 240 and the plurality of sub-controllers 220. The I/O scheduling module 240 is configured to communicate with an external apparatus, receive a data access response initiated by an external apparatus, or feed back an access response to an external apparatus.

The I/O scheduling module 240 is separately connected to the plurality of sub-controllers 220. The I/O scheduling module 240 stores data address information of each region 140 in the storage medium 110, and the data address information of each region 140 records a data address of the region 140. The I/O scheduling module 240 determines, based on a data address carried in a data access instruction sent by the external apparatus and the data address information of each region 140, a sub-controller 220 that can process the data access instruction, where the data address carried in the data access instruction is a data address of a region 140 corresponding to the sub-controller 220. After receiving the data access instruction, the sub-controller 220 may feed back an access response to the I/O scheduling module 240, and the I/O scheduling module 240 may feed back the access response to the external apparatus that initiates the data access instruction.

In this connection manner, the I/O scheduling module 240 can learn of the data address information of each region 140, complete scheduling of the data access instruction, and feed back the received data access instruction to the sub-controller 220 that can process the data access instruction.

FIG. 9B is a topology diagram of a connection between a plurality of sub-controllers 220 according to an embodiment of this disclosure. In FIG. 9B, the medium controller 210 includes two I/O scheduling modules 240 and four sub-controllers 220. For ease of description, the I/O scheduling modules 240 are respectively an I/O scheduling module 240A and an I/O scheduling module 240B. The four sub-controllers 220 are respectively referred to as a sub-controller 220A, a sub-controller 220B, a sub-controller 220C, and a sub-controller 220D. Regions 140 corresponding to the sub-controller 220A, the sub-controller 220B, the sub-controller 220C, and the sub-controller 220D are respectively referred to as a region 140A, a region 140B, a region 140C, and a region 140D. The I/O scheduling module 240A and the I/O scheduling module 240B are respectively connected to different processors outside the storage 10.

The I/O scheduling module 240A is separately connected to the sub-controller 220A, the sub-controller 220B, the sub-controller 220C, and the sub-controller 220D. The I/O scheduling module 240B is separately connected to the sub-controller 220A, the sub-controller 220B, the sub-controller 220C, and the sub-controller 220D.

The I/O scheduling module 240A and the sub-controller 220A are used as an example. When the I/O scheduling module 240A receives a data access instruction sent by an external processor, the I/O scheduling module 240A determines, based on a data address carried in the data access instruction and data address information of each region 140, that the data address carried in the data access instruction is a data address of the region 140A. This indicates that a sub-controller 220 that can process the data access instruction is the sub-controller 220A. The I/O scheduling module 240A sends the data access instruction to the sub-controller 220A. After receiving the data access instruction, the sub-controller 220A processes the data access instruction. After processing the data access instruction, the sub-controller 220A feeds back an access response to the I/O scheduling module 240A. The I/O scheduling module 240A feeds back the access response to the external processor.

The foregoing descriptions of the storage 10 focus on processing of the data access instruction by the medium controller 210 and access to the storage medium 110. In this embodiment of this disclosure, the storage 10 may also have another function. For example, the storage 10 may have a chip-level test function. In other words, the storage 10 can perform a function test on the entire storage medium wafer 100. Content of the function test includes but is not limited to a read/write test, a delay test, a life test, and a temperature test.

The read/write test is to test whether the storage 10 can perform read/write operations normally. The delay test is to test whether duration consumed by the storage 10 in a read/write process is within a preset delay range. The life test indicates whether a bank 130 in the storage 10 can reach preset maximum read/write times. Generally, some banks 130 specially used for the life test are reserved in the storage 10. These banks 130 used for the life test are disabled after the life test because the maximum read/write times are reached. The life test is performed only on some banks 130 in the storage 10, but not on all banks 130 in the storage medium 110. The temperature test is to test whether the storage 10 can perform read/write operations normally at a room temperature or within a preset operating temperature of the storage 10.

The storage 10 can perform a function test, and record a bank 130 that fails the test and a die 120 to which the bank 130 that fails the test belongs. The storage 10 can notify the bank 130 that fails the FT and the die 120 to which the bank 130 that fails the FT belongs to an external part of the storage 10, for example, a processor.

In the storage 10, as shown in FIG. 10, the storage 10 further includes a test module 300, and the test module 300 is configured to implement the FT. A type of the test module 300 is not limited in this disclosure. The test module 300 may be a processor core, and the processor core can load software to complete the function test. Alternatively, the test module 300 may be an ASIC, an FPGA, or another programmable logic device, a discrete gate or a transistor logic device, a discrete hardware component, or the like. All modules that can implement the FT are applicable to this embodiment of this disclosure.

Externally, the test module 300 may directly communicate with an external apparatus, receive an instruction used by an external apparatus for instructing to perform a test, or notify an external apparatus to transmit the bank 130 that fails the test and the die 120 to which the bank 130 that fails the test belongs. For example, an external apparatus of the test apparatus may have an independent interface, and the test module 300 communicates with the external apparatus through the interface. The test module 300 may alternatively transmit information to an external apparatus by using the medium controller 210. For example, the test module 300 is connected to the medium controller 210, the external apparatus may instruct the medium controller 210 to perform a function test, and the medium controller 210 may initiate, to the test module 300, an instruction instructing to perform a test. After receiving the instruction, the test module 300 completes the function test, and sends, to the medium controller 210, the bank 130 that fails the test and the die 120 to which the bank 130 that fails the test belongs. The medium controller 210 notifies the external apparatus of the bank 130 that fails the test and the die 120 to which the bank 130 that fails the test belongs.

Deployment locations and a quantity of the test modules 300 are not limited in this embodiment of this disclosure. For example, the test module 300 may be deployed on the storage medium wafer 100, or may be deployed on the wafer 200 on which the medium controller 210 is disposed.

For another example, the storage 10 may include a plurality of test modules 300, each test module 300 corresponds to one region 140 in the storage medium wafer 100, and the test module 300 is configured to implement a function test for the corresponding region 140. For another example, the storage 10 may include one test module 300, and the test module 300 is configured to implement a function test for the storage medium 110.

In the foregoing descriptions, an example in which the test module 300 configured to perform a function test is independently deployed in the storage 10 is used for description. In actual application, the test module 300 may not be deployed in the storage 10, and the medium controller 210 implements the test function. In other words, the medium controller 210 can perform a function test on the storage medium wafer 100. A manner in which the medium controller 210 performs the function test on the storage medium wafer 100 is similar to a manner in which the test module 300 performs the function test on the storage medium wafer 100. For details, refer to the foregoing descriptions. Details are not described herein again.

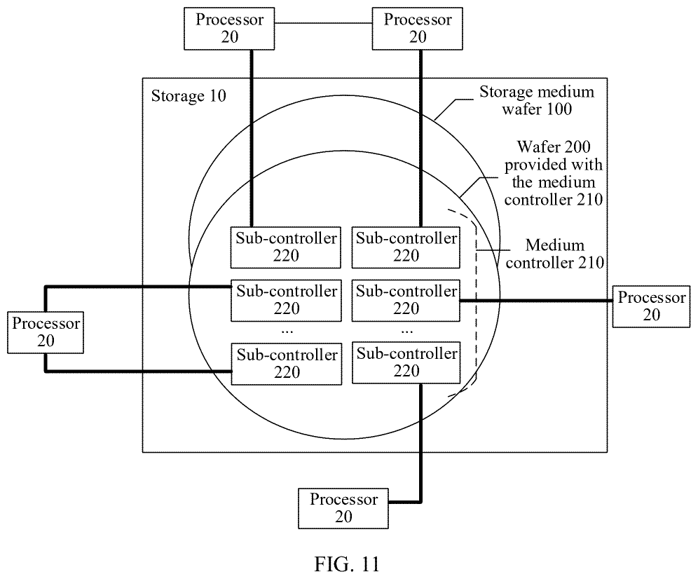

FIG. 11 shows a computing device according to an embodiment of this disclosure. The computing device includes a storage 10 and processors 20. A quantity of processors 20 is not limited in this disclosure. Each processor 20 may be connected to one or more sub-controllers 220 of a medium controller 210 in the storage 10 through a system bus. The system bus may be a Peripheral Component Interconnect Express (PCIe)-based line, or may be a Compute Express Link (CXL), a unified bus (UB), a Cache Coherent Interconnect for Accelerators (CCIX) protocol bus, or another protocol bus. The system bus may be classified into an address bus, a data bus, a control bus, or the like.

The processor 20 may be a central processing unit (CPU), or may be an ASIC, or a programmable logic device (PLD). The PLD may be a complex programmable logical device (CPLD), an FPGA, generic array logic (GAL), a data processing unit (DPU), an SoC, or any combination thereof.

A processor 20 is used as an example. If there is no connection between the plurality of sub-controllers 220 of the medium controller 210 in the storage 10, the processor 20 can only access data in a region 140 corresponding to the sub-controller 220 connected to the storage 10, in other words, the processor 20 can write data into the region 140 only by using the sub-controller 220, or read data from the region 140 by using the sub-controller 220.

If the plurality of sub-controllers 220 of the medium controller 210 in the storage 10 are connected to each other, the processor 20 can access data in each region 140 of a storage medium 110 in the storage 10, in other words, the processor 20 can write data into any region 140 of the storage medium 110 by using the connected sub-controller 220, or read data from any region 140 of the storage medium 110 by using the connected sub-controller 220. A connection and an interaction manner between the sub-controllers 220 in the storage 10 may be described above, and details are not described herein again.

When an I/O module 230 or an I/O scheduling module 240 is disposed in the storage 10, the processor 20 may be connected to the I/O module 230 or the I/O scheduling module 240 in the storage 10 through the system bus. The processor 20 can access data in each region 140 of the storage medium 110 in the storage 10. A connection and an interaction manner between the sub-controller 220 and the I/O module 230 or the I/O scheduling module 240 in the storage 10 may be described above, and details are not described herein again.

Apparently, a person skilled in the art may make various modifications and variations to embodiments of this disclosure without departing from the scope of embodiments of this disclosure. In this case, this disclosure is intended to cover these modifications and variations of embodiments of this disclosure provided that they fall within the scope of protection defined by the following claims and their equivalent technologies.

1. A storage, comprising:
a first wafer configured to store data and comprising a first plurality of regions, wherein each of the first plurality of regions region comprises a second plurality of dice, and wherein each of the second plurality of dice comprises a third plurality of banks;
a second wafer stacked with the first wafer; and
a medium controller disposed on the second wafer, connected to each of the third plurality of banks, and configured to:
receive a data access instruction; and
access, based on the data access instruction, one of the third plurality of banks.

2. The storage of claim 1, wherein the medium controller comprises a fourth plurality of sub-controllers, and wherein each of the fourth plurality of sub-controllers corresponds to one of the first plurality of regions, is connected to each of the third plurality of banks in the one of the first plurality of regions, and is configured to:
receive the data access instruction; and
access, based on the data access instruction, one of the third plurality of banks in the one of the first plurality of regions.

3. The storage of claim 2, wherein the sub-controllers are configured to communicate with each other by using a network-on-chip (NoC).

4. The storage of claim 2, wherein the sub-controllers are connected to each other, and wherein each of the fourth plurality of sub-controllers is further configured to transmit, to another one of the fourth plurality of sub-controllers, the data access instruction when the sub-controller cannot process the data access instruction.

5. The storage of claim 2, wherein each of the fourth plurality of sub-controllers is connected to an adjacent one of the fourth plurality of sub-controllers and is further configured to transmit, to the adjacent one of the fourth plurality of sub-controllers, the data access instruction when the sub-controller cannot process the data access instruction.

6. The storage of claim 2, wherein the sub-controllers are connected in series to form a ring, and wherein each of the fourth plurality of sub-controllers is further configured to broadcast, by using the ring, the data access instruction when the sub-controller cannot process the data access instruction.

7. The storage of claim 2, wherein the medium controller further comprises an input/output (I/O) circuit, wherein the I/O circuit and the fourth plurality of sub-controllers are connected in series to form a ring, wherein the I/O circuit is configured to:
connect, through a system bus, to an apparatus outside of the storage;
receive the data access instruction; and
broadcast, by using the ring, the data access instruction, and
wherein and the sub-controller is further configured to listen to the ring to obtain the data access instruction.

8. The storage of claim 2, wherein each of the fourth plurality of sub-controllers is further configured to store data address information of the one of the first plurality of regions corresponding to the sub-controller, wherein the data address information records a first data address of the one of the first plurality of regions, and wherein a second data address carried in the data access instruction that cannot be processed by the sub-controller is not the first data address.

9. The storage of claim 1, wherein the storage further comprises a test circuit configured to:
perform, on the first wafer, a function test comprising a part or all of a read/write test, a delay test, a life test, or a temperature test;
record, in the first wafer, one of the third plurality of banks that fails the function test and one of the second plurality of dice comprising the one of the third plurality of banks.

10. The storage of claim 1, wherein the medium controller is further configured to:
perform, on the first wafer, a function test comprising a part or all of a read/write test, a delay test, a life test, or a temperature test;
record, in the first wafer, one of the third plurality of banks that fails the function test and one of the second plurality of dice comprising the one of the third plurality of banks.

11. A computing device, comprising:
one or more processors configured to send a data access instruction; and
a storage comprising:
a first wafer configured to store data and comprising a first plurality of regions, wherein each of the first plurality of regions region comprises a second plurality of dice, and wherein each of the second plurality of dice comprises a third plurality of banks;
a second wafer stacked with the first wafer; and
a medium controller disposed on the second wafer, is connected to each of the third plurality of banks, and configured to:
receive, from the one or more processors, the data access instruction; and
access, based on the data access instructions, one of the third plurality of banks.

12. The computing device of claim 11, wherein the medium controller comprises a fourth plurality of sub-controllers, and wherein the one or more processors are connected to one or more of the fourth plurality of sub-controllers.

13. The computing device of claim 11, wherein the medium controller comprises a fourth plurality of sub-controllers, and wherein each of the fourth plurality of sub-controllers corresponds to one of the first plurality of regions, is connected to each of the third plurality of banks in the one of the first plurality of regions, and is configured to:
receive the data access instruction; and
access, based on the data access instruction, one of the third plurality of banks in the one of the first plurality of regions.

14. The computing device of claim 12, wherein the sub-controllers are connected to each other, and wherein each of the fourth plurality of sub-controllers is further configured to transmit, to another one of the fourth plurality of sub-controllers, the data access instruction when the sub-controller cannot process the data access instruction.

15. The computing device of claim 12, wherein each of the fourth plurality of sub-controllers is connected to an adjacent one of the fourth plurality of sub-controllers and is further configured to transmit, to the adjacent one of the fourth plurality of sub-controllers, the data access instruction when the sub-controller cannot process the data access instruction.

16. The computing device of claim 12, wherein the sub-controllers communicate with each other by using a network-on-chip (NoC).

17. The computing device of claim 11, wherein the storage further comprises a test circuit configured to:
perform, on the first wafer, a function test comprising a read/write test; and
record, in the first wafer, one of the third plurality of banks that fails the function test and one of the second plurality of dice comprising the one of the third plurality of banks.

18. The computing device of claim 11, wherein the storage further comprises a test circuit configured to:
perform, on the first wafer, a function test comprising a delay test; and
record, in the first wafer, one of the third plurality of banks that fails the function test and one of the second plurality of dice comprising the one of the third plurality of banks.

19. The computing device of claim 11, wherein the storage further comprises a test circuit configured to:
perform, on the first wafer, a function test comprising a life test; and
record, in the first wafer, one of the third plurality of banks that fails the function test and one of the second plurality of dice comprising the one of the third plurality of banks.

20. The computing device of claim 11, wherein the storage further comprises a test circuit configured to:
perform, on the first wafer, a function test comprising a temperature test; and
record, in the first wafer, one of the third plurality of banks that fails the function test and one of the second plurality of dice comprising the one of the third plurality of banks.
